(19) United States
(12) Patent Application Publication
(10) Pub. No.: US 2024/0300543 A1
(43) Pub. Date: Sep. 12, 2024

(54) SYSTEMS AND METHODS FOR LATENCY-TOLERANT ASSISTANCE OF AUTONOMOUS VEHICLES

(71) Applicant: ROBOCARS INC., Pittsburgh, PA (US)

(72) Inventors: Ragunathan RAJKUMAR, Monroeville, PA (US); Sandeep D'SOUZA, Pittsburgh, PA (US)

(21) Appl. No.: 18/258,483

(22) PCT Filed: Dec. 20, 2021
(86) PCT No.: PCT/US2021/064349

§ 371 Date: Jun. 20, 2023

Related U.S. Application Data
(60) Provisional application No. 63/127,917, filed on Dec. 18, 2020.

(51) Int. Cl. B60W 60/00; B60W 50/14; B60W 50/16; G05D 1/224; G05D 1/227

(52) U.S. Cl. CPC B60W 60/0053; B60W 50/16; G05D 1/2247; G05D 1/227; B60W 2050/146; B60W 2554/402; B60W 2554/80; B60W 2754/10

(57) ABSTRACT

Systems and methods for latency-tolerant assistance of autonomous vehicles (AVs) are described herein. In one aspect, a computer-implemented method for receiving latency-tolerant assistance of an AV can include receiving sensory data from the AV; detecting from the sensory data a trigger for assistance; generating a request for assistance including at least a portion of the sensory data of the AV; receiving, in response to the request for assistance, an operator command for responding to the trigger for assistance; and initiating one or more actuation commands via an actuation subsystem of the AV in response to the received operator command.

### CROSS-REFERENCE TO RELATED APPLICATION

This application claims priority under 35 U.S.C. § 119(e) to U.S. Provisional Patent Application No. 63/127,917, titled “Systems and Methods for Latency-Tolerant Assistance of Autonomous Vehicles” and filed Dec. 18, 2020. The entire content of this application is hereby incorporated by reference herein.

### BACKGROUND OF THE INVENTION

Autonomous vehicles (AVs) are vehicles that can operate themselves without the need for operation by a human driver. AVs, like normal, human-driven vehicles, encounter unique road scenarios regularly. However, unlike human-driven vehicles, AVs may encounter driving situations where the underlying software subsystem is unable to adapt, analyze, or react appropriately. Further, constant remote control of an AV by a human driver is impractical, as wireless communications between the remote operator and the AV would experience high latency, which can seriously reduce the effectiveness of the control and hamper operational safety. There exists a need for the AV to drive itself as much as possible but also taking human input for AV decision-making in certain conditions, while mitigating the adverse effects of high-latency communications experienced by the AV. When the AV is driving itself but needs assistance at some point in time, human input cannot however be expected to be provided immediately since it can take humans some time to assess the operating conditions, make a decision and provide inputs. The AV therefore can request human assistance only when a latency of up to a few seconds in getting human inputs is feasible. Such latency-tolerant assistance is at the core of this invention. When an AV seeks latency-tolerant assistance, that history can also be used to provide guidance of an anticipatory nature to other AVs.

### SUMMARY OF THE INVENTION

Systems and methods for latency-tolerant assistance of autonomous vehicles (A Vs) are described herein. In one aspect, a computer-implemented method for receiving latency-tolerant assistance of an AV can include receiving sensory data from the AV; detecting from the sensory data a trigger for assistance; generating a request for assistance including at least a portion of the sensory data of the AV; receiving, in response to the request for assistance, an operator command for responding to the trigger for assistance; and initiating one or more actuation commands via an actuation subsystem of the AV in response to the received operator command.

This aspect can include a variety of embodiments. In one embodiment, the method can further include transmitting the request for assistance to a remote operator station, presenting the request for assistance to an occupant of the AV; or a combination thereof.

In another embodiment, the method can further include presenting the request for assistance via an output interface including a display console, a speaker, tactile feedback, or a combination thereof, on the AV.

In another embodiment, receiving the operator command can include receiving input via an input interface including a wireless communications interface, a touchscreen, a switch, a button, a knob, a keyboard, a computer mouse, a drawing pad, a camera, a microphone, or a combination thereof on the AV.

In another embodiment, detecting the trigger for assistance further includes identifying one or more objects external to the AV from the sensory data; determining a classification for each of the one or more objects via a plurality of characteristics of the object; and determining that one or more objects creates an assistance event for the AV based at least on the classification type of the object. In some cases, detecting the trigger for assistance further includes determining a distance and direction of the object with respect to the AV, a direction of travel for the AV, a speed of travel for the AV, or a combination thereof; and where the determining the object creates the assistance event for the AV is further based on the distance and direction of the object with respect to the AV, the direction of travel for the AV, the speed of travel for the AV, or the combination thereof.

In another embodiment, the sensory data includes video data received from a plurality of cameras of the AV, laser data received from a plurality of lidar sensors of the AV, radar targets received from a plurality of radar sensors of the AV, ultrasound objects detected from a plurality of ultrasonic sensors of the AV, audible sounds received from a plurality of microphones of the AV, vehicle dynamics data from a plurality of inertial management units, processed outputs from the sensory data of the AV; or a combination thereof.

In another embodiment, the sensor data includes a front view from the AV, a side view from the AV, a rear view from the AV, or a combination thereof.

In another embodiment, detecting the trigger for assistance further includes identifying a passage of time past a time threshold with no progress in a position of the AV; and determining the passage of time creates an assistance event for the AV based at least on the duration of the time interval, a driving context of the AV, or a combination thereof. In some cases, detecting the trigger for assistance further includes determining a distance and direction of the object with respect to the AV, a direction of travel for the AV, a speed of travel for the AV, or a combination thereof; and where the determining the object creates the assistance event for the AV is further based on the distance and direction of the object with respect to the AV, the direction of travel for the AV, the speed of travel for the AV, or the combination thereof.

In another embodiment, the one or more operator commands received by the AV are latency-tolerant and include an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV, information to be presented to an occupant of the AV, or a combination thereof.

In another embodiment, the method can further include storing the trigger for assistance, parameters associated with the detecting the trigger for assistance, the one or more actuation commands, or a combination thereof, in a remote database; receiving additional sensory data from the AV; and detecting another trigger for assistance from at least in part the additional sensory data and the stored trigger for assistance, parameters associated with the detecting the trigger for assistance, the one or more actuation commands, or the combination thereof.

In another aspect, a non-transitory, computer-readable media for latency-tolerant assistance of an AV can include one or more processors; a memory; and code stored in the memory that, when executed by the one or more processors, cause the one or more processors to: receive sensory data from the AV; detect from the sensory data a trigger for assistance; generate a request for assistance comprising at least a portion of the sensory data of the AV; receive, in response to the request for assistance, an operator command for responding to the trigger for assistance; and initiate one or more actuation commands via an actuation subsystem of the AV in response to the received operator command.

In another aspect, a computer-implemented method for receiving forward-looking assistance of an AV can include transmitting, by the AV, route information, sensory data, or a combination thereof to an operator; receiving one or more operator instructions for altering AV driving behavior, route, path, speed, vehicle status, or a combination thereof; and initiating one or more actuation commands via an actuation subsystem of the AV in response to the received operator instructions.

This aspect can include a variety of embodiments. In one embodiment, the method can further include transmitting the route information, the sensory data, or the combination thereof to a remote operator station; presenting the route information, the sensory data, or the combination thereof to an occupant of the AV; or a combination thereof. In some cases, the presenting is performed via an output interface including a display console, a speaker, tactile feedback, or a combination thereof on the AV.

In some embodiments, receiving the operator instructions can include receiving input from a remote operator station, a user interface of the AV, or a combination thereof.

In some embodiments, the operator instructions are generated by one or more computers, via an input interface including a touchscreen, a switch, a button, a knob, a keyboard, a computer mouse, a drawing pad, a camera, a microphone, or a combination thereof, on the AV.

In some embodiments, the sensory data can include video data received from a plurality of cameras of the AV; laser data received from a plurality of lidar sensors of the AV, radar targets received from a plurality of radar sensors of the AV, ultrasound objects detected from a plurality of ultrasonic sensors of the AV, audible sounds received from a plurality of microphones of the AV, vehicle dynamics data from a plurality of inertial management units, processed outputs from the sensory data of the AV; or a combination thereof.

In some embodiments, the sensory data can include a front view from the AV, a side view from the AV, a rear view from the AV, or a combination thereof.

In another embodiment, the operator instructions can include one or more look-ahead actions specifying an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof; wherein the one or more look-ahead actions define either a time period for the AV to wait before initiating the one or more actuation commands, or waiting for a trigger event to occur prior to initiating the one or more actuation commands.

In another aspect, a computer-implemented method to provide latency-tolerant assistance to an AV can include receiving a trigger for assistance from an AV; receiving at least a portion of the sensory data from an AV; and generating one or more operator commands for the AV.

This aspect can include a variety of embodiments. In one embodiment, the one or more operator commands are latency-tolerant communications, and specify an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV; information to be presented to an occupant of the AV, or a combination thereof.

In another embodiment, the method can further include storing the trigger for assistance, parameters associated with detecting the trigger for assistance, the one or more actuation commands, or a combination thereof, in a database.

In another embodiment, the method can further include presenting the sensory data received from the AV via one or more displays, speakers, tactile feedback interfaces, or a combination thereof.

In another embodiment, the method can further include generating the one or more operator commands via an input interface including a touchscreen, a keyboard, a drawing pad, a microphone, a camera, or a combination thereof.

In another embodiment, the method can further include authenticating an operator via an interface prior to initiating one or more operator commands.

In another embodiment, the method can further include storing one or more sensory data streams from the AV, one or more recordings of the operator providing assistance to the AV, or a combination thereof.

In another aspect, a computer-implemented method to provide look-ahead guidance to an AV can include determining a threshold is met for providing look-ahead guidance to the AV based on data comprising changes in road maps, traffic conditions, road conditions, weather conditions, lighting conditions, regulations, news events, or a combination thereof; and transmitting look-ahead guidance to the AV, where the AV initiates one or more actuation commands based on the look-ahead guidance.

This aspect can include a variety of embodiments. In one embodiment, the look-ahead guidance includes one or more operator instructions including an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

In another embodiment, the method can further include storing the operator guidance, a set of conditions that triggered the operator guidance, or a combination thereof.

In another embodiment, the method can further include extracting recent history of operator guidance for the AV from a database; where the generating the operator guidance is further based on the extracted recent history.

In another aspect, a computer-implemented method to provide look-ahead guidance to an AV can include receiving location information, look-ahead routing information, sensory information, or a combination thereof from the AV; and determining a threshold to provide look-ahead guidance to the AV is met based on the location information, look-ahead routing information, sensory information, or the combination thereof sent by the AV.

This aspect can include a variety of embodiments. In one embodiment, the look-ahead guidance can include one or more look-ahead actions including an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

In another embodiment, the method can further include storing the look-ahead guidance, the location information, the look-ahead routing information, the sensory information, a set of trigger conditions that triggered the operator guidance, or a combination thereof, in a database.

In another aspect, a computer-implemented method to provide look-ahead guidance to one or more AVs can include receiving location information, look-ahead routing information, sensory information, or a combination thereof from the AV; and determining a threshold to provide look-ahead guidance to the AV is met based on the location information, look-ahead routing information, sensory information, or the combination thereof sent by the AV.

This aspect can include a variety of embodiments. In one embodiment, the look-ahead guidance can include one or more look-ahead actions including an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

In another embodiment, the method can further include storing the look-ahead guidance, the location information, the look-ahead routing information, the sensory information, a set of trigger conditions that triggered the operator guidance, or a combination thereof, in a database.

In another aspect, a computer-implemented method to provide look-ahead guidance to one or more AVs can include receiving sensory data, operating status, remote assistance information, route information, or a combination thereof from a first set of A Vs; receiving look-ahead routing information, location, sensory data, or a combination thereof from a second set of AVs; determining a threshold to guide the second set of AVs is met also based on the sensory data, operating status, remote assistance information, route information, or the combination thereof from the first set of AVs; and transmitting look-ahead instructions to the second set of AVs, where each of the second set of AVs initiates one or more actuation commands based on the look-ahead instructions.

This aspect can include a variety of embodiments. In one embodiment, the look-ahead instructions can include one or more look-ahead actions including an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

In another embodiment, the method can further include storing the look-ahead instructions, the look-ahead routing information, the location, the sensory data, the set of trigger conditions for the look-ahead instructions, or a combination thereof, in a database.

In another embodiment, the method can further include receiving from a plurality of AVs route information of the respective AVs; determining from the route information a group of AVs subject to at least one road segment requiring guidance; broadcasting to the group of AVs the operator guidance based on the determining.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an autonomous vehicle (AV) according to an embodiment of the claimed invention.

FIG. 2 depicts a communication swim diagram for latency-tolerant assistance of an AV, according to an embodiment of the claimed invention.

FIGS. 3 and 4 depict software subsystems for an AV according to embodiments of the claimed invention.

FIG. 5 depicts a remote monitor operator (RMO) interface with an AV according to an embodiment of the claimed invention.

FIGS. 6-9 depict various illustrated perspectives of an AV according to embodiments of the claimed invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Systems and methods for latency-tolerant assistance to autonomous vehicles (AVs) are described herein. AVs are plagued with various technical challenges, such as a lack of perfect sensing, map, localization, and decision-making abilities. These “gaps” in AV abilities can be supplemented with input received from a remote monitor operator (RMO) or a local monitor operator (LMO). An RMO can be a computer system (e.g., hardware and software) configured to communicate with the AV (e.g., a communication subsystem or software subsystem of the AV) and is located remotely (e.g., in a different physical location) from the AV. An LMO can likewise be a computer system configured to communicate with the AV and is located in close proximity to the AV, such as within the interior of the AV.

According to embodiments of the claimed invention, an AV can identify an event requiring assistance. The AV can receive sensory data corresponding to the AV's proximal external environment and determine from the sensory data that assistance from an RMO or LMO is required. The AV can generate a request for assistance and transmit the request, along with at least some of the sensory data indicating the assistance requirement, to the LMO or RMO. The RMO or LMO can provide instructions to the AV for responding to the identified scenario requiring assistance.

Thus, an RMO or LMO can fill in technical and information gaps for AVs, thereby allowing AVs to be “road-ready” without the need for a fully autonomous AV. The RMO or LMO input can also provide a second of layer of safety and assurance for AV actions and decisions without the need for a driver to be at the wheel of the AV.

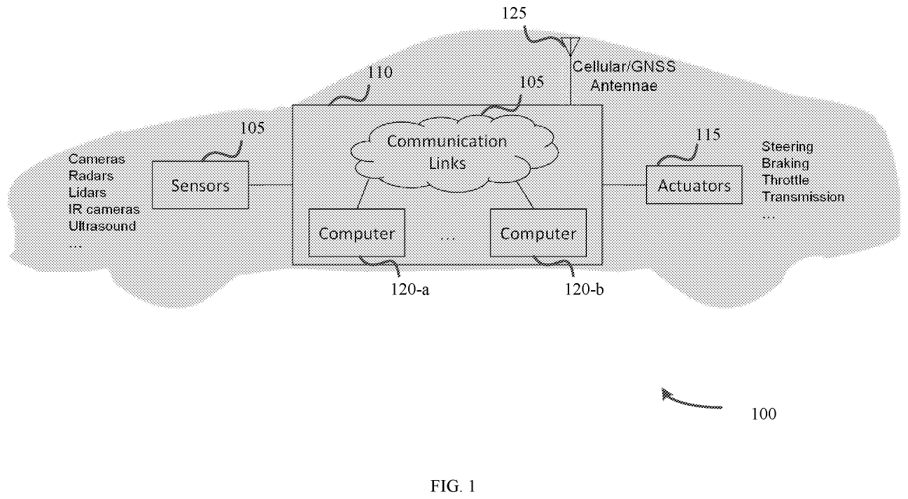

FIG. 1 depicts an AV 100 according to an embodiment of the claimed invention. The AV 100 can include one or more sensors 105, a software subsystem 110, and an actuator subsystem 115. Although shown as an image of car, the AV can be a multitude of vehicles, such as passenger vehicles, freight vehicles, mass transit vehicles, delivery vehicles, military vehicles, rail vehicles, airborne vehicles, water surface vehicles, underwater vehicles, and the like.

The sensors 105 of the AV can capture or receive data corresponding to the external environment. The sensor(s) 105 can be equipped on the exterior and/or the interior of the AV 100. For example, sensors 105 can be located on the windshield, the front bumper, the rear bumper, the rear windshield, a passenger or driver door, the fenders, the roof, the undercarriage, the hood, the dashboard, the trunk, a side mirror, and the like. Further, the sensors 105 can be in electronic communication with the software subsystem 110 (e.g., either directly via hardwiring or via the transceiver 125). Examples of sensors 105 can be, but are not limited to, cameras, radars, lidars, infrared (IR) cameras, thermal cameras, night-vision cameras, microphones, and the like.

The software subsystem 110 of the AV 100 can control certain functions of the AV 100. For example, the software subsystem 110 can receive sensory data from the sensors 105. In some cases, the software subsystem 110 can also activate the sensors 105, or instruct the sensors to collect certain sensory data (e.g., night vision data, thermal data, and the like).

The software subsystem 110 can also control the actuation subsystem 115. The actuation subsystem 115 can include components of the AV 100 that actuate the vehicle. For example, the actuation subsystem 115 can include a steering column, brakes, throttle, transmission, turn signals, horn, and the like. The software subsystem 110 can be in electronic communication with the actuation subsystem 115, and can send electronic commands or instructions to the actuation subsystem 115 for various components of the subsystem 115 to actuate the AV 100.

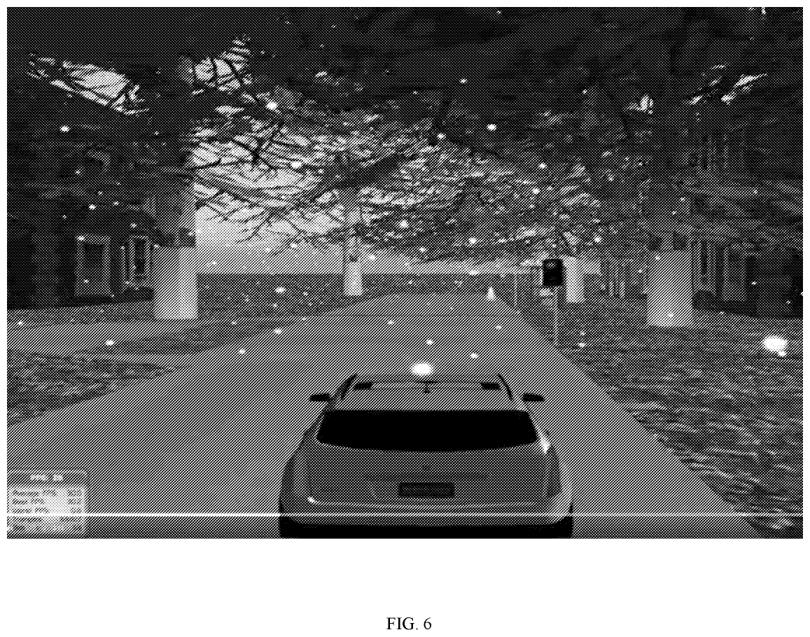

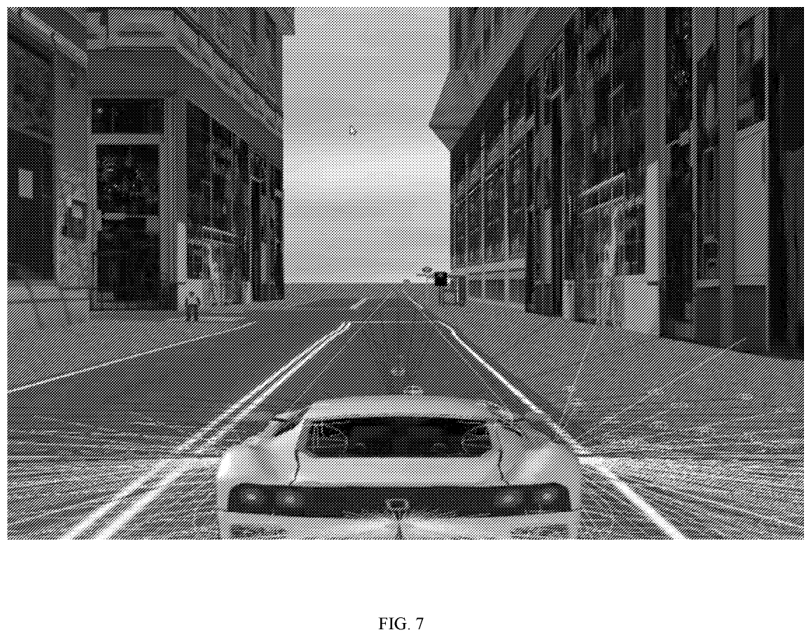

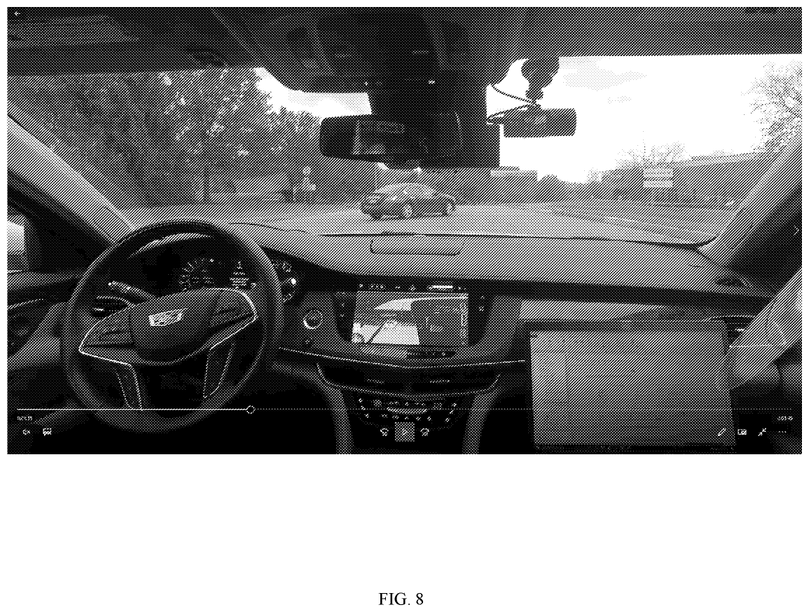

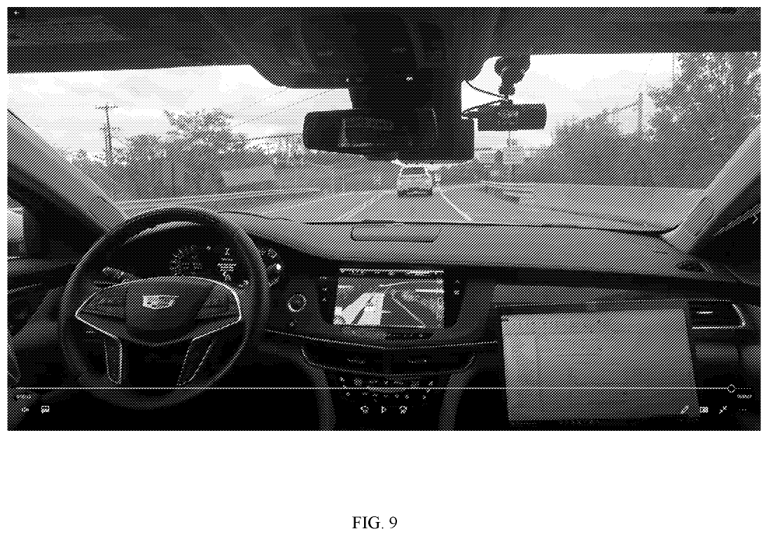

The software subsystem 110 can include one or more computers 120. FIG. 1 depicts two computers 120-a and 120-b, but more or fewer computers can be included in the software subsystem 115. The computers 120 can each include one or more of a central processing unit (CPU), a graphics processing unit (GPU), a machine learning accelerator, an image processing unit (IPU), a signal processor, and the like. In some cases, each computer 120 can be in electronic communication with the other computers 120, for example via the communication links 125. Thus, a computer 120 can function in series or in parallel with another computer 120. FIGS. 6 and 7 depict images of an AV and it surrounding environment, while FIGS. 8 and 9 depict interior views of an AV.

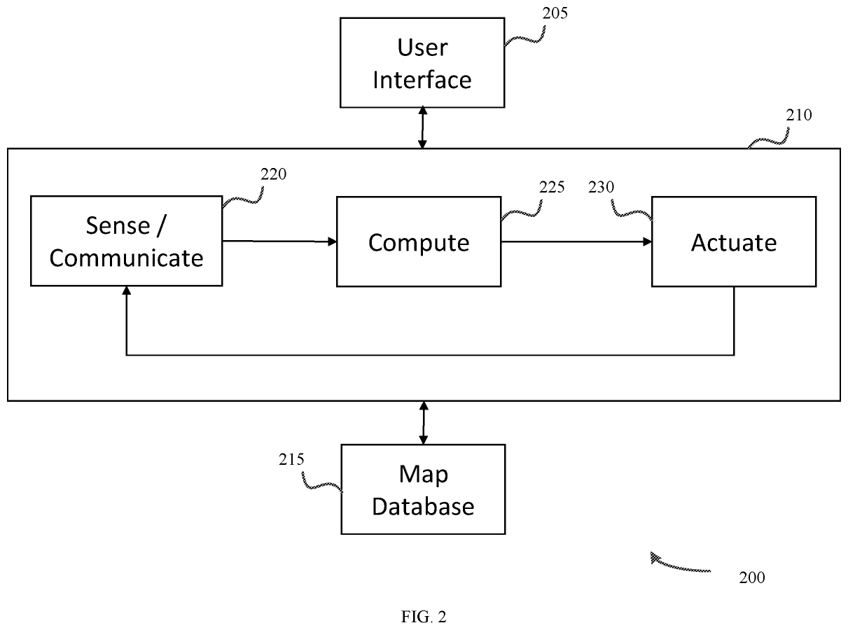

FIG. 2 depicts a software subsystem 200 according an embodiment of the claimed invention. The software subsystem 200 can be an example of the software subsystem 110 as described with reference to FIG. 1. The software subsystem can include a user interface 205, one or more computers 210, and may also include a map database 215.

The user interface 205 can be any component configured to receive user input and/or to provide information to the user. For example, the user interface 205 can be a display console configured to provide visual information to the user and/or to receive user input via a touchscreen, a keyboard, and the like. Other examples of a user interface can include a speaker configured to provide aural information to the user, a microphone configured to receive auditory commands, a console configured to generate tactile feedback, or a combination thereof. In some cases, the user input can be received via wireless communications, a touchscreen, a switch, a button, a knob, a keyboard, a computer mouse, a drawing pad, a camera, a microphone, and the like.

The one or more computers 210 can be in electronic communication with the user interface 205 and the map database 215. The computers 210 can perform various processes for the AV, including decision-making processes for the AV, the generation of actuation commands for the AV, analyses of the sensory information, and the like. For example, the computers 210 can include sense/communication processes 220, compute processes 225, and actuate processes 230.

The sense/communication processes 220 can include receiving and/or transmitting information from various sources external to the software subsystem 200. For example, the computers 210 can receive sensory data from one or sensors of the AV, such as from the sensors 105 as described in FIG. 1. In some cases, the computers 210 can receive communications, for example, from the user interface 205 or from the transceiver 125 (e.g., via wirelessly) as described in FIG. 1. The communications can be from either an RMO or an LMO, and can in some cases be instructions or commands from the RMO/LMO, or requests for information from the RMO/LMO.

In some cases, the communications can be transmitted from the computers 210. For example, the computers (e.g., via the transceiver or user interface) can transmit requests for assistance to an RMO/LMO, which can include sensory data. In some cases, the computers can transmit feedback or confirmation information to the LMO/RMO, or to a database for storage.

The compute processes 225 can include processes corresponding to how the AV reacts to scenarios and/or the surrounding environment the AV is experiencing. For example, based on received sensory data, and/or communications received from a LMO/RMO, the computers 210 can determine a request for assistance threshold is met. In some cases, the AV can determine a threshold for assistance is met based on identified characteristics and parameters of the sensory data received from sensors. In some cases, the computers 210 can receive feedback or instructions from an LMO/RMO, such as instructions for reacting to a particular situation or environment the AV is experiencing. As such, the computers 210 can compute how to implement the received instructions.

The actuate processes 230 can include processes for actuating the AV in response to the sense/communicate processes 220. For example, the AV can include a variety of actuators, for example, the actuators can include steering column, brakes, throttle, transmission, turn signals, and the like. The computers 210 can generate commands for actuating an actuator or actuators of the AV. For example, computers 210 can generate an actuation command such as an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, sticking to a lane bordered by a specified set of workzone artifacts such as cones and barrels, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV, and the like.

The software subsystem 200 can optionally include a map database 215. The map database 215 can store a set of driving maps for the AV. For example, the map database 215 can store maps with roadways, along with geographical coordinates for the roadways and other points of interest. In some cases, the computers 210 can implement any of the sense/communication processes 220, the compute processes 225, and the actuate processes 230 utilizing the map data stored in the map database 215.

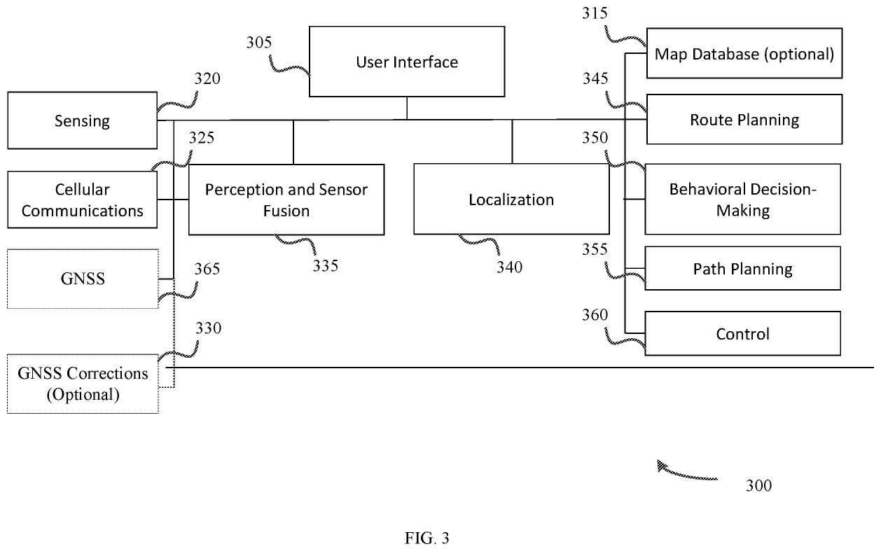

FIG. 3 depicts a software subsystem 300 according to an embodiment of the claimed invention. The software subsystem 300 can be an example of software subsystem 110 of FIG. 1, or software subsystem 200 of FIG. 2. The software subsystem 300 can include a user interface 305, an optional map database 315, a sensing component 320, a cellular communications component 325, an optional GNSS corrections component 330, a perception and sensor fusion component 335, a localization component 340, a route planning component 345, a behavioral decision-making component 350, a path planning component 355, and a control component 360. However, one skilled in the art will understand that different architectures may be structured for implementing the functions described below, and fall within the scope of the disclosure.

The software subsystem 300 can include a user interface 305, which can be an example of the user interface 205 of FIG. 2. The software subsystem 300 can also include an optional map database 315, which can be an example of the map database 215 of FIG. 2.

The sensing component 320 can transmit and receive communications to and from the sensors of the AV, such as sensors 105 of FIG. 1. For example, the sensing component 320 can receive sensory data from sensors, and can transmit commands, instructions, feedback, acknowledgments, and the like, to the sensors.

The cellular communications component 325 can transmit and receive wireless communications to and from the AV. For example, the cellular communications component 325 can transmit and receive commands, instructions, feedback, acknowledgments, sensory data, requests for assistance, and the like, to an LMO/RMO, storage database, etc. In some cases, the cellular communications component 325 can receive or transmit communication from and to, or can be a part of, the transceiver 120 of FIG. 1.

The GNSS component 365 can, for example, receive GPS data from satellites pertaining to geographical coordinates of the AV. The GNSS corrections component 330 can analyze and correct satellite positions corresponding to the AV. For example, the GNSS corrections component 330 can receive a geographical position of the AV via satellite communications. The GNSS corrections component 330 can receive GNSS corrections parameters from a processing center, and can apply these correction parameters to received GNSS positioning data.

The perception and sensor fusion component 335 can receive sensory data and generate compiled data pertaining to the AV environment. For example, the perception and sensor fusion component 335 can receive sensory data from a variety of sensors (e.g., multiple cameras, GPS data, audio data, vehicle data, and the like). The perception and sensor fusion component 335 can compile this sensory data to generate aggregated sensory information, such as a panoramic view of a front-facing perspective of the AV, a side view while traversing an intersection, a rear view while backing up, or a rear side view while changing lanes, the location and type of the lanemakers and road boundaries, for example.

The localization component 340 can localize a position of the AV. For example, the localization component 340 can receive data from GNSS satellites for localizing the AV, receive and communicate with GNSS correction stations which in turn can be used to determine the position of the AV at a given time. In some cases, the localization component 340 can receive map data from the map database 315 and subsequently determine the position of the AV in relationship to the map data. In some other cases, the localization component 340 can receive data from the perception and sensor fusion component 335 to determine the position of the AV. In one embodiment of the invention, the localization component 340 can be part of the perception and sensor fusion component 335.

The route planning component 345 can plan a route that the AV can drive along. In some cases, the route is generated when the AV begins its current trip from a starting point to a destination specified by the user using the user interface component 305 or an RMO/LMO. In some cases, the route can be dynamically modified, for example, due to the detection of a road closure by the perception and sensor fusion component 335. In some other cases, the route can be modified when a shorter, faster or more energy-efficient route becomes available. The route can also be modified due to a latency-tolerant assistance command from an RMO/LMO, or due to a look-ahead guidance.

The behavior planning component 350 determines how the AV must drive towards its destination taking into account traffic rules and regulations, as well as current traffic conditions in the operating environment around the AV. For example, the behavior planning component can require that the AV come to a stop at a stop line at an upcoming intersection and take its turn, that the AV go through an intersection controlled by a traffic light which is currently green, that the AV continue through an intersection if the traffic light just turned yellow and there is not enough time or distance to come to a stop, that the AV come to a stop at a red traffic light, that the AV yield to merging traffic, that the AV go ahead of merging traffic, that the AV ought to change lanes, that the AV must make a turn at an intersection, that the current maximum speed of the AV is a certain value, and the like. The behavior planning component can take as its inputs data from the perception and sensor fusion component 335, the localization component 340, optionally the map database component 315, and/or the route generated by the route planning component 345. In some cases, the behavior planning component can determine its outputs based on the weather conditions, lighting conditions, road conditions and traffic conditions detected by the perception and sensor fusion component 335.

The path planning component 355 determines the speed at which the AV should drive at and the pathway the AV should follow in the immediate future, that can be up to several seconds. For example, the path planning component can receive the data from the perception and sensor fusion component 335 to determine whether there are any immediate obstacles on the road, The path planning component can read or receive data from the map database component 315 to determine where on the map the AV should be and how the AV should be oriented. The path planning component can receive data from the behavior decision-making component 350 to know the maximum speed to use, whether and when the AV needs to accelerate, slow down or come to a stop. The path planning component attempts to make forward progress while keeping the vehicle safe at all times, by generating the path and speed profiles for the AV in the near term.

In one embodiment of this invention, the route-planning component 345, the behavioral decision-making component 350, the path planning component 360, and the localization component 340, or various combinations thereof can constitute the compute component 225 in FIG. 2. In another embodiment of this invention, some compute functions of the control component 360 can also be part of the compute component 225 in FIG. 2.

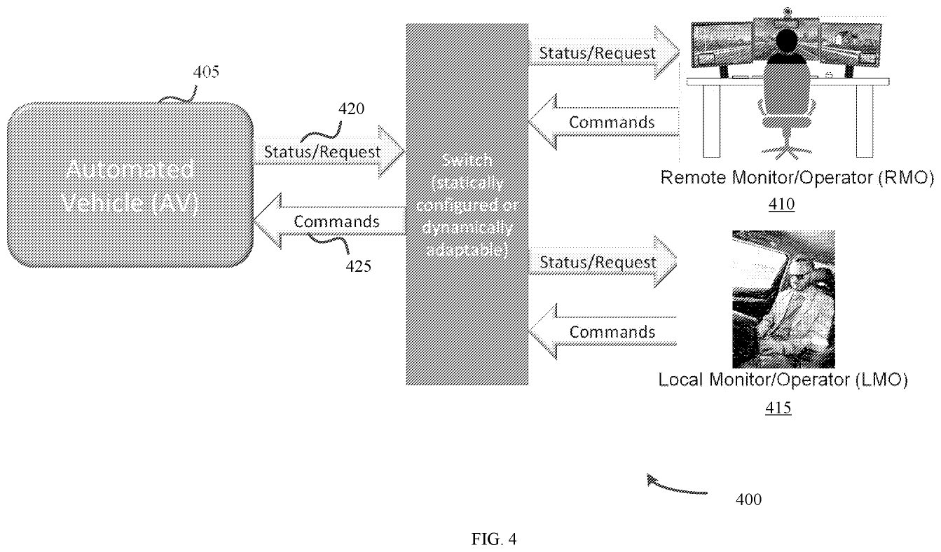

The control component 360 sends commands to the actuators of the AV to drive the vehicle at the appropriate speed and direction. It can take its inputs for the desired speed and pathway from the path planning component and fulfils those requirements as quickly and comfortably as possible. The control component can also take optional inputs from the map database 345, the behavioral decision-making component 350, the localization component 340, and the perception and sensor fusion component 335. In one embodiment of this invention, the control component can issue commands to and read the status of the vehicle actuators in the actuators component 115 in FIG. 1. In another embodiment of this invention, the control component performs the functions of the actuate component 210 in FIG. 2. FIG. 4 depicts a swim flow process 400 for latency-tolerant assistance for an AV, according to an embodiment of the claimed invention. The swim flow process can include an AV 405, an RMO 410, and an LMO 415. The AV 405 can be an example of the AV 100 described with reference to FIG. 1. The RMO 410 can be in wireless communication with the AV 405, and can be remote from the AV 405. Likewise, the LMO 415 can be in wireless, wired, aural or visual communication with the AV 405, and can be local to the AV 405. For example, the LMO 415 can be positioned within the interior of the AV 405.

The AV 405 can receive sensory data from one or more sensors. For example, the AV can receive images captured by a camera of the AV. Examples of sensory data can include, but are not limited to, video data received from one or more cameras of the AV, laser data received from one or more lidar sensors of the AV, radar data received from a one or more radar sensors of the AV, ultrasound data detected from one or more ultrasonic sensors of the AV, audible sounds received from one or more microphones of the AV, vehicle dynamics data from a plurality of inertial management units of the AV, the current physical parameters of the AV (speed, etc.), the processed outputs from the sensory data of the AV, and the like.

The AV can identify various objects external to the AV based on the sensory data. For example, the AV can identify objects within captured image data. Some objects that the AV can identify can include, but are not limited to, roadway objects such as the road, road curvature, lane markers, road shoulders, road medians, pot holes, road debris, road blockage, and other road damage; objects in proximity to the AV such as other vehicles, pedestrians, animals, vegetation, roadside artifacts, workzone artifacts, road workers, personal objects, and the like.

Object identification can occur based on the identification of characteristics of the object in question. For example, the physical outline, estimated size, colors, and position of the object can be determined by the AV, which in turn can rely on these characteristics to determine a classification or type of the object. In some cases, the AV can fail to determine a classification for an object, in which case the AV can label the object as unknown.

From the identified objects, the AV can determine whether a threshold for assistance is met. The AV (e.g., the software subsystem of the AV) can store predetermined assistance thresholds. An example threshold can include identifying an object classification is present in proximity to the AV. In some cases, an object position relative to the AV can also be included in the threshold. In some cases, an object speed of travel can also be included in the threshold. In some cases, an object direction of travel can also be included in the threshold. In some cases, the AV's speed can also be included in the threshold. In some cases, the AV's direction of travel can also be included in the threshold.

Thresholds for assistance can also be triggered by events other than object detection and identification. These other event types can include the passage of time for example. An AV may detect that it has not made any forward progress for an extended period of time and can issue a request for assistance. The time threshold itself may change based on the time of day, whether it is a holiday, weekend or weekday, location, news events, and other like factors. The AV may also find that the information in the map database 215 component in FIG. 2 does not match that is visible to the AV as it navigates the roads. This mismatch in turn can trigger a request for assistance.

An AV can also issue a request for assistance on an “anticipatory” basis. For example, instead of waiting until actual assistance is required, an AV can issue a request for assistance in anticipation of requiring it in the near future which may be minutes, hours or even days in the future. Such an anticipatory request can be used to allocate an RMO/LMO to assist the AV as needed, and can also enable the AV to continue its progress without stopping or waiting later to get the required assistance.

An AV can also issue a request for assistance based on its operating context. For example, the AV may be programmed to deal with specific weather conditions, lighting conditions, road conditions, traffic conditions, or combinations thereof. The driving context of the AV may however encounter a different set of operating conditions, and can trigger the AV to request assistance.

Once an assistance threshold is met, the AV can generate a request for assistance. The AV 405 can transmit a communication to either the LMO 410 or the RMO 415 requesting assistance (e.g., communication 420). The request can include at least a portion of the sensory data captured by the sensors of the AV. The request communication can be transmitted to either the LMO or the RMO based on a configuration setting (e.g., a setting which can be set by an LMO, RMO, administrator, and the like), or can be dynamically determined by the AV (e.g., based on the type of request, and the like).

In some cases, the request for assistance can be received by the RMO 410. The RMO 410 can include a user input device and a request output device. The user input device can include, but is not limited to, a touchscreen, a switch, a button, a knob, a keyboard, a computer mouse, a drawing pad, a camera, a microphone, and the like. The output device can communicate with the AV transmitting the assistance request using cellular communications 325 in FIG. 3 in one embodiment of the invention. The output device can also be a part of the input device (e.g., a display of a touchscreen), or can be separate, such as one or more displays, speakers, and the like.

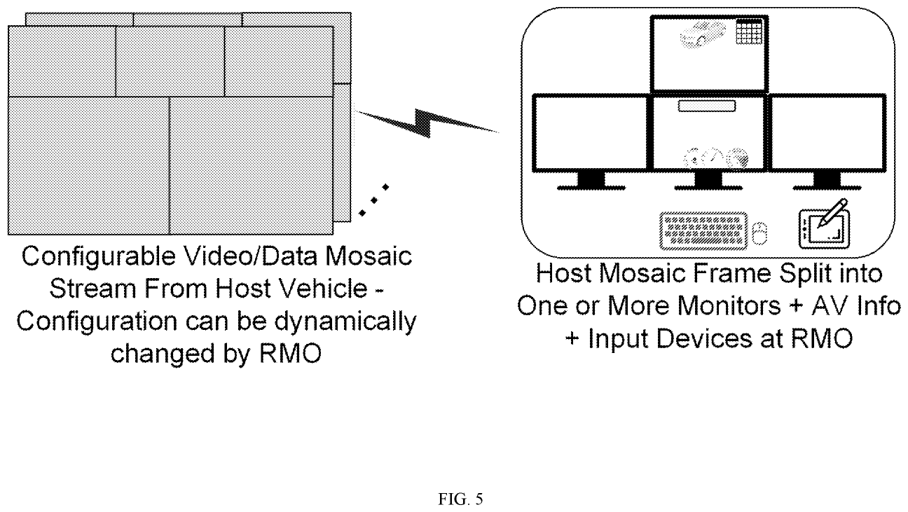

The output device of the RMO 410 can receive the request for assistance and can generate an alert indicative of the request, can output the request via the output device, or both. The output device of the RMO 410 can also output sensory data received from the AV, for example camera images captured by sensors of the AV. The AV data can also indicate the reasons for which the request for assistance was transmitted (e.g., what threshold for assistance was determined to be met by the AV). In some cases, the sensory data can be transmitted to accommodate the output devices of the RMO, for example as shown in FIG. 5. The RMO 410 can receive input via the input device (e.g., received from a user of the RMO 410) that can correspond to a command or instructions for the AV. The RMO 410 can then generate operator commands based on the received input. The command or instructions can be in response to the request for assistance, and can also be transmitted via the output device (e.g. using the cellular communications component 325 in FIG. 3) to the AV requesting assistance.

Likewise, in some cases, the request for assistance can be received by the LMO 415. The LMO 415 can be located within the interior of the AV, and can include a user input device and a request output device, similar to the RMO 410. The user input device can include, but is not limited to, a touchscreen, a switch, a button, a knob, a lever, a keyboard, a computer mouse, a drawing pad, a camera, a microphone, and the like. In some cases, the input device can be a dashboard of the AV. The output device can be a part of the input device or can be separate, such as a display, speakers, and the like.

The output device of the LMO 415 can receive the request for assistance and can generate an alert indicative of the request, can output the request via the output device, or both. The output device of the LMO 415 can also output sensory data received from the AV. The LMO 415 can receive input via the input device (e.g., received from a user of the LMO 415) that can correspond to a command or instructions for the AV. The LMO 415 can then generate operator commands based on the received input. The command or instructions can be in response to the request for assistance.

Example operator commands can include but are not limited to, an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lane markers, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV; information to be presented to an occupant of the AV, and the like. The operator commands, and the request for assistance communications, can be transmitted and received over telecommunications systems, satellite communications systems and the like. Thus, these communications can include a high-latency characteristic between transmission and reception, such as a 1-second latency, -second latency, and the like.

The AV can receive the operator commands from the RMO 410 or LMO 415 and implement the commands. The AV (e.g., the software subsystem) can generate a set of instructions for the actuator subsystem based on the received operator commands. For example, the AV may receive operator commands for increasing or decreasing the speed of the AV. The software subsystem can determine a speed threshold for the AV based on the operator commands, and can generate an actuation commands for a throttle component or a brake component of the AV. In one embodiment of this invention, the operator command or instructions can be sent as inputs to the perception and sensor fusion component 335, localization component 340, route planning component 350, behavior decision-making component 350, path planning component 355, or combinations thereof, in FIG. 3. In another embodiment of this invention, the command or instructions can be sent to the control component 360 in FIG. 3. For example, AV flashers can be turned on or off, turn signals can be turned on or off, the horn can be activated, the doors can be locked or unlocked, or combinations thereof.

In some cases, the operator commands include various other action thresholds for the AV to satisfy in response to the scenario requiring assistance. For example, the operator command can specify a defined or undefined time period for the AV to continue transmitting its sensory information to the operator until another object or object movement via the sensory data triggers a different operator command for the AV (e.g., a construction worker providing hand gestures to move, turn or stop). As another example, the operator command can request the AV to continue sending its sensory information to the operator until an ‘all clear’ operator command is sent, to ensure that the AV is operating safely and independently again.

When an AV requests assistance from an LMO, RMO or both, the AV may be unable to operate autonomously on its own. These RMO interventions can be expensive from an operating standpoint, and LMO interventions from inside the vehicle can be discomforting or distracting. Hence, RMO and LMO assistance requests need to be minimized. In order to reduce AV requests for assistance, RMO commands can be sent to one or more AVs preemptively, such that one AV can avoid a scenario (e.g., a traffic jam) that another AV has already experienced (and may have already generated a trigger for assistance for). This type of operator commands can be considered as “look-ahead” guidance, and can be issued minutes, hours or days before an AV assist request can be potentially issued. In some cases, the look-ahead guidance can be generated based on other information such as routing information (e.g., roadmaps, weather conditions, traffic data, and the like) as well as sensory data from the AV or other AVs. For example, if an AV detects a road closure or a construction workzone, it can issue a request for assistance. After responding to this request, the RMO/LMO can store the information and transmit/broadcast the information to any AV that may traverse that region or route subsequently. An AV receiving such look-ahead guidance can then re-route itself around the closure or workzone, and hence not need to issue a request for assistance. To further facilitate the reduction of AV requests for assistance, an AV can communicate its route information at the beginning of its journey, and an RMO/LMO can provide appropriate look-ahead guidance before or around the beginning of the journey itself.

The AV can also store event data corresponding to the request for assistance. For example, the AV can store the sensory data, the prompt for generating the request for assistance (e.g., what caused the AV to determine an assistance threshold was met), resulting operator commands received from the RMO or LMO, actuation commands generated, and the like. This event data can be stored either locally (e.g., within a subsystem of the AV), or remotely.

The AV can subsequently implement this event data as data points in a machine learning program. The machine learning program can include algorithms such as Decision Trees, Linear Regression, Neural Networks, Apriori, K-means Clustering, Q-Learning, and the like. The event data can be part of the training data set for the machine learning program, where the program subsequently adjusts or modifies program parameters. The AV can rely on the machine learning program to adjust parameters related to object identification, request for assistance thresholds, actuation commands, and the like. In some cases, the AV can implement the machine learning program to adjust the request for assistance thresholds, such that the AV minimizes requests for assistance from an LMO or RMO by recognizing past operator commands from similar scenarios encountered. In some cases, these similar scenarios can be encountered by other AVs, and event data can be stored in aggregate from multiple AVs.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method for receiving latency-tolerant assistance of an autonomous vehicle (AV), comprising:
receiving sensory data from the AV;
detecting from the sensory data a trigger for assistance;
generating a request for assistance comprising at least a portion of the sensory data of the AV;
receiving, in response to the request for assistance, an operator command for responding to the trigger for assistance; and
initiating one or more actuation commands via an actuation subsystem of the AV in response to the received operator command.

2. The computer-implemented method of claim 1, further comprising:
transmitting the request for assistance to a remote operator station, presenting the request for assistance to an occupant of the AV; or a combination thereof.

3. The computer-implemented method of claim 1, further comprising:
presenting the request for assistance via an output interface comprising a display console, a speaker, tactile feedback, or a combination thereof, on the AV.

4. The computer-implemented method of claim 1, wherein receiving the operator command comprises receiving input via an input interface comprising a wireless communications interface, a touchscreen, a switch, a button, a knob, a keyboard, a computer mouse, a drawing pad, a camera, a microphone, or a combination thereof on the AV.

5. The computer-implemented method of claim 1, wherein detecting the trigger for assistance further comprises:
identifying one or more objects external to the AV from the sensory data;
determining a classification for each of the one or more objects via a plurality of characteristics of the object; and
determining that one or more objects creates an assistance event for the AV based at least on the classification type of the object.

6. The computer-implemented method of claim 5, wherein detecting the trigger for assistance further comprises:
determining a distance and direction of the object with respect to the AV, a direction of travel for the AV, a speed of travel for the AV, or a combination thereof; and wherein the determining the object creates the assistance event for the AV is further based on the distance and direction of the object with respect to the AV, the direction of travel for the AV, the speed of travel for the AV, or the combination thereof.

7. The computer-implemented method of claim 1, wherein the sensory data comprises video data received from a plurality of cameras of the AV, laser data received from a plurality of lidar sensors of the AV, radar targets received from a plurality of radar sensors of the AV, ultrasound objects detected from a plurality of ultrasonic sensors of the AV, audible sounds received from a plurality of microphones of the AV, vehicle dynamics data from a plurality of inertial management units, processed outputs from the sensory data of the AV; or a combination thereof.

8. The computer-implemented method of claim 1, wherein the sensor data comprises a front view from the AV, a side view from the AV, a rear view from the AV, or a combination thereof.

9. The computer-implemented method of claim 1, wherein detecting the trigger for assistance further comprises:
identifying a passage of time past a time threshold with no progress in a position of the AV; and
determining the passage of time creates an assistance event for the AV based at least on the duration of the time interval, a driving context of the AV, or a combination thereof.

10. The computer-implemented method of claim 9, wherein detecting the trigger for assistance further comprises:
determining a distance and direction of the object with respect to the AV, a direction of travel for the AV, a speed of travel for the AV, or a combination thereof; and wherein the determining the object creates the assistance event for the AV is further based on the distance and direction of the object with respect to the AV, the direction of travel for the AV, the speed of travel for the AV, or the combination thereof.

11. The computer-implemented method of claim 1, wherein the one or more operator commands received by the AV are latency-tolerant and comprise an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV; information to be presented to an occupant of the AV, or a combination thereof.

12. The computer-implemented method of claim 1, further comprising:
storing the trigger for assistance, parameters associated with the detecting the trigger for assistance, the one or more actuation commands, or a combination thereof, in a remote database;
receiving additional sensory data from the AV; and
detecting another trigger for assistance from at least in part the additional sensory data and the stored trigger for assistance, parameters associated with the detecting the trigger for assistance, the one or more actuation commands, or the combination thereof.

13. A non-transitory, computer-readable media for latency-tolerant assistance of an autonomous vehicle (AV), comprising:
one or more processors;
a memory; and
code stored in the memory that, when executed by the one or more processors, cause the one or more processors to:
receive sensory data from the AV;
detect from the sensory data a trigger for assistance;
generate a request for assistance comprising at least a portion of the sensory data of the AV;
receive, in response to the request for assistance, an operator command for responding to the trigger for assistance; and
initiate one or more actuation commands via an actuation subsystem of the AV in response to the received operator command.

14. A computer-implemented method for receiving forward-looking assistance of an autonomous vehicle (AV), comprising:
transmitting, by the AV, route information, sensory data, or a combination thereof to an operator;
receiving one or more operator instructions for altering AV driving behavior, route, path, speed, vehicle status, or a combination thereof; and
initiating one or more actuation commands via an actuation subsystem of the AV in response to the received operator instructions.

15. The computer-implemented method of claim 14, further comprising:
transmitting the route information, the sensory data, or the combination thereof to a remote operator station; presenting the route information, the sensory data, or the combination thereof to an occupant of the AV; or a combination thereof.

16. The computer-implemented method of claim 15, wherein the presenting is performed via an output interface comprising a display console, a speaker, tactile feedback, or a combination thereof on the AV.

17. The computer-implemented method of claim 14, wherein receiving the operator instructions comprises receiving input from a remote operator station, a user interface of the AV, or a combination thereof.

18. The computer-implemented method of claim 14, wherein the operator instructions are generated by one or more computers, via an input interface comprising a touchscreen, a switch, a button, a knob, a keyboard, a computer mouse, a drawing pad, a camera, a microphone, or a combination thereof, on the AV.

19. The computer-implemented method of claim 14, wherein the sensory data comprise video data received from a plurality of cameras of the AV; laser data received from a plurality of lidar sensors of the AV, radar targets received from a plurality of radar sensors of the AV, ultrasound objects detected from a plurality of ultrasonic sensors of the AV, audible sounds received from a plurality of microphones of the AV, vehicle dynamics data from a plurality of inertial management units, processed outputs from the sensory data of the AV; or a combination thereof.

20. The computer-implemented method of claim 14, wherein the sensory data comprises a front view from the AV, a side view from the AV, a rear view from the AV, or a combination thereof.

21. The computer-implemented method of claim 14, wherein the operator instructions comprise one or more look-ahead actions specifying an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof; wherein the one or more look-ahead actions define either a time period for the AV to wait before initiating the one or more actuation commands, or waiting for a trigger event to occur prior to initiating the one or more actuation commands.

22. A computer-implemented method to provide latency-tolerant assistance to an autonomous vehicle (AV), comprising:
receiving a trigger for assistance from an AV;
receiving at least a portion of the sensory data from an AV; and
generating one or more operator commands for the AV.

23. The computer-implemented method of claim 22, wherein the one or more operator commands are latency-tolerant communications, and specify an increase in AV speed (or speed limit), a decrease in AV speed (or speed limit), maintaining AV speed, instructing the AV to drive around one or more obstacles, instructing the AV to drive over or through one or more obstacles, a continuation of the AV in its current state, maintaining a stationary status until further notice, a gear selection of the AV, a horn initiation, an initiation of vehicle flashers, an emergency alert initiation, an unlocking or locking of a door of the AV, opening or closing of a window of the AV, a headlight initiation of the AV, a direction change of the AV, a route change of the AV, changes to a map used by the AV, a turn instruction for the AV, a lane change of the AV, a re-routing of the AV, a lateral offset in the travel direction of the AV, driving on a road shoulder, driving off-road, following a driving path specified in the operator command, driving over a shoulder, following a specified set of lanemarkers, yielding to other vehicles at an intersection, performing a zipper merge at a merge point, instructing the AV to take its turn, instructing the AV to merge, positioning the AV over to a shoulder of a road, stopping the AV, yielding to an emergency vehicle, requiring manual takeover of the AV; information to be presented to an occupant of the AV, or a combination thereof.

24. The computer-implemented method of claim 22, further comprising:
storing the trigger for assistance, parameters associated with detecting the trigger for assistance, the one or more actuation commands, or a combination thereof, in a database.

25. The computer-implemented method of claim 22, further comprising:
presenting the sensory data received from the AV via one or more displays, speakers, tactile feedback interfaces, or a combination thereof.

26. The computer-implemented method of claim 22, further comprising:
generating the one or more operator commands via an input interface comprising a touchscreen, a keyboard, a drawing pad, a microphone, a camera, or a combination thereof.

27. The computer-implemented method of claim 22, further comprising:
authenticating an operator via an interface prior to initiating one or more operator commands.

28. The computer-implemented method of claim 22, further comprising:
storing one or more sensory data streams from the AV, one or more recordings of the operator providing assistance to the AV, or a combination thereof.

29. A computer-implemented method to provide look-ahead guidance to an autonomous vehicle (AV), comprising:
determining a threshold is met for providing look-ahead guidance to the AV based on data comprising changes in road maps, traffic conditions, road conditions, weather conditions, lighting conditions, regulations, news events, or a combination thereof, and
transmitting look-ahead guidance to the AV, wherein the AV initiates one or more actuation commands based on the look-ahead guidance.

30. The computer-implemented method of claim 29, wherein the look-ahead guidance comprises one or more operator instructions comprising an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

31. The computer-implemented method of claim 29, further comprising:
storing the operator guidance, a set of conditions that triggered the operator guidance, or a combination thereof.

32. A computer-implemented method to provide look-ahead guidance to an autonomous vehicle (AV), comprising:
receiving location information, look-ahead routing information, sensory information, or a combination thereof from the AV; and
determining a threshold to provide look-ahead guidance to the AV is met based on the location information, look-ahead routing information, sensory information, or the combination thereof sent by the AV.

33. The computer-implemented method of claim 32, wherein the look-ahead guidance comprises one or more look-ahead actions comprising an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

34. The computer-implemented method of claim 32, further comprising:
storing the look-ahead guidance, the location information, the look-ahead routing information, the sensory information, a set of trigger conditions that triggered the operator guidance, or a combination thereof, in a database.

35. A computer-implemented method to provide look-ahead guidance to one or more autonomous vehicles (AVs), further comprising:
receiving sensory data, operating status, remote assistance information, route information, or a combination thereof from a first set of AVs;
receiving look-ahead routing information, location, sensory data, or a combination thereof from a second set of AVs;
determining a threshold to guide the second set of AVs is met also based on the sensory data, operating status, remote assistance information, route information, or the combination thereof from the first set of AVs; and
transmitting look-ahead instructions to the second set of AVs, wherein each of the second set of AVs initiates one or more actuation commands based on the look-ahead instructions.

36. The computer-implemented method of claim 35, wherein the look-ahead instructions comprise one or more look-ahead actions comprising an increase in AV speed, a decrease in AV speed, maintaining AV speed, driving the AV around one or more obstacles, driving the AV over or through one or more obstacles, a continuation of the AV in its current state, maintaining a stationary status, a gear selection of the AV, a horn initiation, an emergency alert initiation, an unlocking or locking of a door of the AV, opening or closing of a window of the AV, a headlight initiation of the AV, a direction change of the AV, a lane change of the AV, a re-routing of the AV, a lateral offset in the travel direction of the AV, driving on a road shoulder, driving off-road, following a driving path specified in the operator request, positioning the AV over to a shoulder of a road, driving over a shoulder, following a specified set of lanemarkers, responding to a specified set of workzone artifacts, stopping the AV and initiating a set of flashers of the AV, monitoring for an emergency vehicle, presenting information to an occupant of the AV, requiring manual takeover of the AV, or a combination thereof.

37. The computer-implemented method of claim 35, further comprising:
storing the look-ahead instructions, the look-ahead routing information, the location, the sensory data, the set of trigger conditions for the look-ahead instructions, or a combination thereof, in a database.

38. The computer-implemented method of claim 35, further comprising:
receiving from a plurality of AVs route information of the respective AVs;
determining from the route information a group of AVs subject to at least one road segment requiring guidance;
broadcasting to the group of AVs the operator guidance based on the determining.

39. The computer-implemented method of claim 14 further comprising:
extracting recent history of operator guidance for the AV from a database; and
wherein the generating the operator guidance is further based on the extracted recent history.

40. The computer-implemented method of claim 29 further comprising:
extracting recent history of operator guidance for the AV from a database; and
wherein the generating the operator guidance is further based on the extracted recent history.
